(19) United States
(12) Patent Application Publication
(10) Pub. No.: US 2002/0105496 A1
(43) Pub. Date: Aug. 8, 2002

(54) Non-visual user interface

(75) Inventors: Cesare Giuliani, Rome (IT); Roberto Longobardi, Rome (IT)

Correspondence Address: IBM Corp, IP Law,, 11400 Burnett Road, Zip 4054, Austin, TX, 78758, US

(73) Assignee: International Business Machines Corporation

(21) Appl. No.: 09/918,870

(22) Filed: Jul. 31, 2001

(30) Foreign Application Priority Data
Feb. 3, 2001 (GB) 0102758.0

(51) Int. Cl. G09G 5/00

(52) U.S. Cl. 345/156

(57) ABSTRACT

The present invention proposes a non-visual output device for providing a non-visual representation of objects comprising means for providing a first non-visual indication consisting of a three-dimensional representation of an object, and means for providing a second non-visual indication representative of a non-shape related attribute (e.g. the presence of a hyperlink) of the object. The devised solution allows more visual information to be conveyed to the user. Therefore, the interaction human/machine is greatly enhanced. Moreover, the device according to the invention gives the user a quick feedback of the visual information; therefore, the user may immediately identify information of particular importance or meaning. The proposed solution is extremely advantageous for the blind people, especially when they are surfing the INTERNET. In fact, the emphasised hyperlinks (or hotspots) give the user an immediate feeling of the links available.

### FIELD OF INVENTION

The present invention relates to a user interface and more particularly to a non-visual input/output device.

### BACKGROUND OF THE INVENTION

Several types of non-visual output devices have been proposed in recent years, for example in order to allow the blind to use a PC (Personal Computer). A non-visual output device generally gives a tactile sensation to a user; the tactile sensation is representative of corresponding visual information (which should be displayed on a monitor).

A solution known in the art consists of using a matrix of pins selectively movable relative to a reference surface. The pins are driven to present raised patterns defining corresponding Braille characters. Moreover, the pins can also be used to provide a three-dimensional representation of any other graphical object (such as a drawing).

A drawback of the non-visual output device described above is that most details of the visual information are not conveyed to the user. As a consequence, the user cannot interact with the computer correctly. This drawback is particularly acute with modern Graphical User Interfaces (GUIs), which exploit a large number of graphical elements (such as windows, menus, and buttons) and corresponding possible conditions (such as focusing or non-focusing, active or inactive (greyed), and normal or highlighted). The situation is even worse when the user wants to access the INTERNET, wherein a great deal of information choices are available to the user; in this case, the typical quick progression through different web pages (surfing) is significantly impaired.

It is an object of the present invention to provide a technique which alleviates the above drawbacks.

### DISCLOSURE OF THE INVENTION

According to the present invention, we provide a non-visual user interface device for representing objects comprising means for providing a first non-visual indication representative of a first attribute of at least one object, characterised in that the device further includes means for providing a second non-visual indication representative of a second attribute of said at least one object.

Also, according to the present invention, we provide a data processing system comprising the non-visual user interface device described above, a memory for storing video information, and means for driving the device according to the video information.

Furthermore, according to the present invention, we provide a method of providing a non-visual representation of objects comprising the steps of: providing a first non-visual indication representative of a first attribute of at least one object, providing a second non-visual indication representative of a second attribute of said at least one object.

### BRIEF DESCRIPTION OF THE DRAWINGS

Further features and the advantages of the solution according to the present invention will be made clear by the following description of a preferred embodiment thereof, given purely by way of a non-restrictive indication, with reference to the attached figures, in which:

FIG. 1 shows a schematic block-diagram of a computer in which the non-visual device of the invention can be used;

FIG. 2 is a diagrammatical representation of a board controlling the non-visual device;

FIG. 3 depicts a monitor of the computer and the non-visual device;

FIG. 4 is an exploded pictorial representation of a particular of the non-visual device;

FIG. 5 shows a flow chart of a method used for controlling the non-visual device.

### DESCRIPTION OF THE PREFERRED EMBODIMENTS

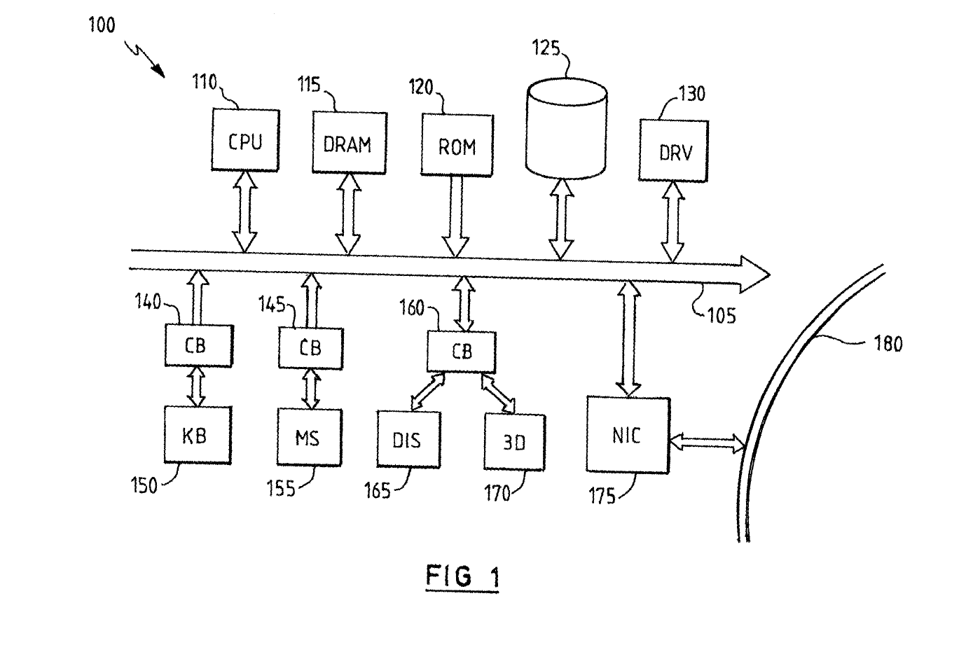

With reference in particular to FIG. 1, there is shown a computer 100, for example a PC (Personal Computer). The computer 100 has several units, which are connected in parallel to a system bus 105. In particular, a central processing unit (CPU) 110 controls the operation of the computer 100, a working memory 115 (typically a DRAM) is used directly by the CPU 110, and a read-only memory (ROM) 120 stores a basic program for starting the computer 100. Various peripheral units are further connected to the bus 105 (by means of respective interfaces). More specifically, a storage memory consists of a hard disk 125 and of a driver unit (DRV) 130 for reading/writing floppy disks and/or CD-ROMs. Two boards (CB) 140 and 145 control a keyboard (KB) 150 and a mouse (MS) 155, respectively; a further board (CB) 160 controls both a monitor (DIS) 165 and a three-dimensional display (3D) 170. A network interface card (NIC) 175 is used to connect the computer 100 to a network 180 (typically the INTERNET).

Similar considerations apply if the computer includes different units (such as a printer, a scanner or a web-cam), or if the computer has a different structure (for example with a multi-processor architecture); alternatively, two distinct control boards are used for the monitor and the three-dimensional display, or no monitor, keyboard and mouse are provided.

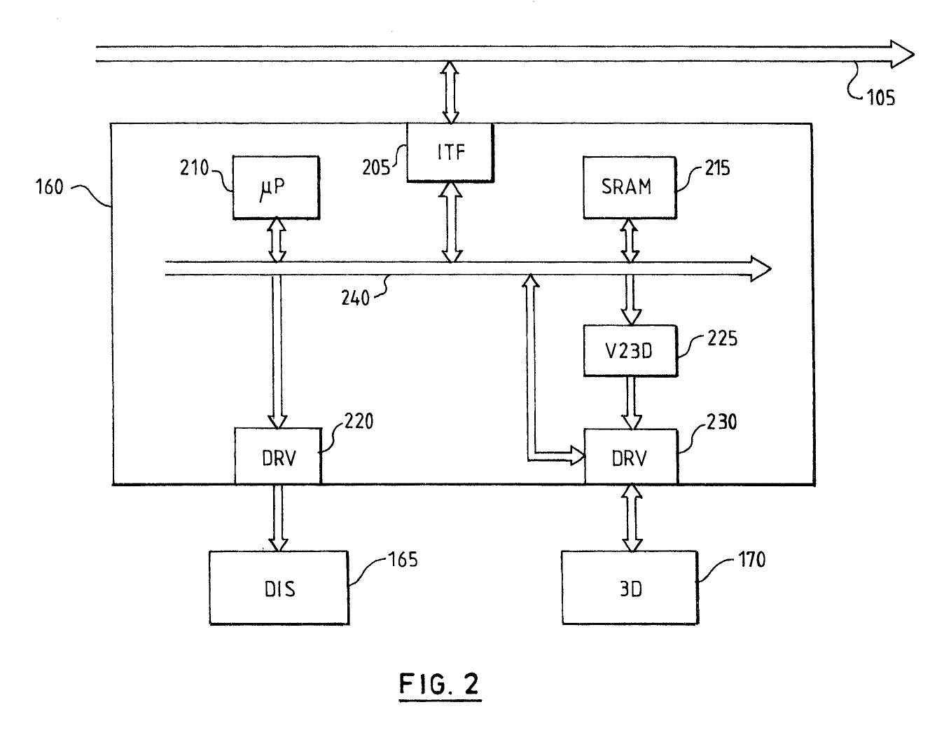

Considering now FIG. 2, the control board 160 includes an interface unit (ITF) 205 for accessing the system bus 105. A microprocessor (mP) 210 controls the operation of the board 160; a working memory 215 (typically a SRAM) stores video information received from the system bus 105. The video information is directly provided to a driver unit (DRV) 220, which controls the monitor 165 accordingly.

The video information is also provided to a conversion unit (V23D) 225. Each character in the video information (such as a letter, a number or a punctuation mark) is transformed into the respective Braille code; any other graphical element (such as an image or a drawing) is transformed into a respective three-dimensional representation by means of an image filter (such as an emboss filter). The converted video information is input to a driver unit (DRV) 230, which controls the three-dimensional display 170 accordingly and also receives feedback information from the same.

The interface unit 205, the microprocessor 210, the working memory 215, the driver unit 220, the conversion unit 225, and the driver unit 230 are connected in parallel to a local bus 240 for sending and/or receiving information.

Likewise considerations apply if the control board has a different structure, if some of the operations are implemented by software, and so on.

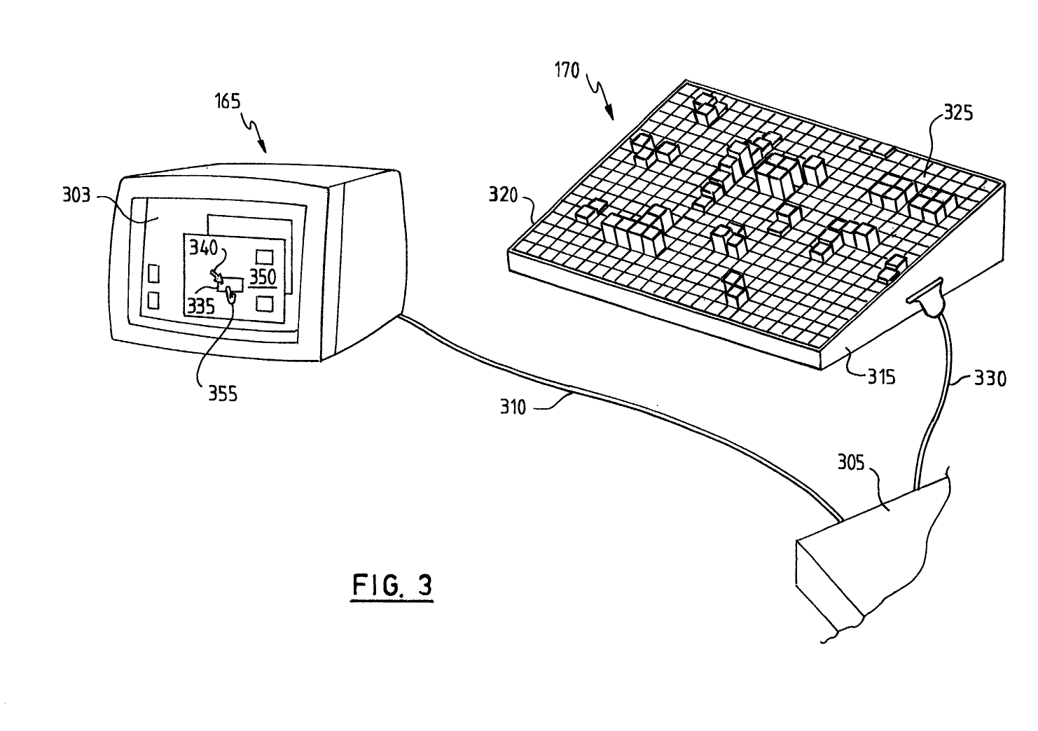

As shown in FIG. 3, the monitor 165 has a screen 303 that is used to display visual information to a sighted user; the monitor 165 is connected to a central unit 305 of the computer (enclosing the system bus and the units directly connected thereto) by means of a cable 310. Conversely, the three-dimensional display 170 is used by a blind user. The three-dimensional display 170 consists of a console 315 having an inclined upper surface 320 (defining a reference surface); the console 315 embeds a matrix of pins 325 (such as a few hundred), which are individually raised and lowered above the reference surface 320 (as describe in detail in the following). The three-dimensional display 170 is connected to the central unit 305 by means of a further cable 330.

Programs running on the computer have a Graphical User Interface (GUI); this interface allows the user to control the programs by using stylised graphical elements 335 (such as windows, dialog boxes, pop-up or pull-down menus, and push or radio buttons), which are displayed on the screen 303 (simulating a desktop). The sighted user interacts with the program by generating a sequence of mouse and keyboard events; a current position on the desktop, to which the mouse points, is denoted with an arrow 340.

The computer can be used to access the INTERNET; the user searches for topics of interest by surfing through web sites and downloading selected web pages. Each web page 350 is displayed in a respective window, and includes different contents (such as text, images, icons, and the like), some of which define a hot spot or hyperlink. A hot spot consists of an element (such as a text or an icon) with a respective link to a different web page, which is activated when the hot spot is selected. The hot spot is generally denoted with an index finger 355, which is shown only when the mouse points to the respective element.

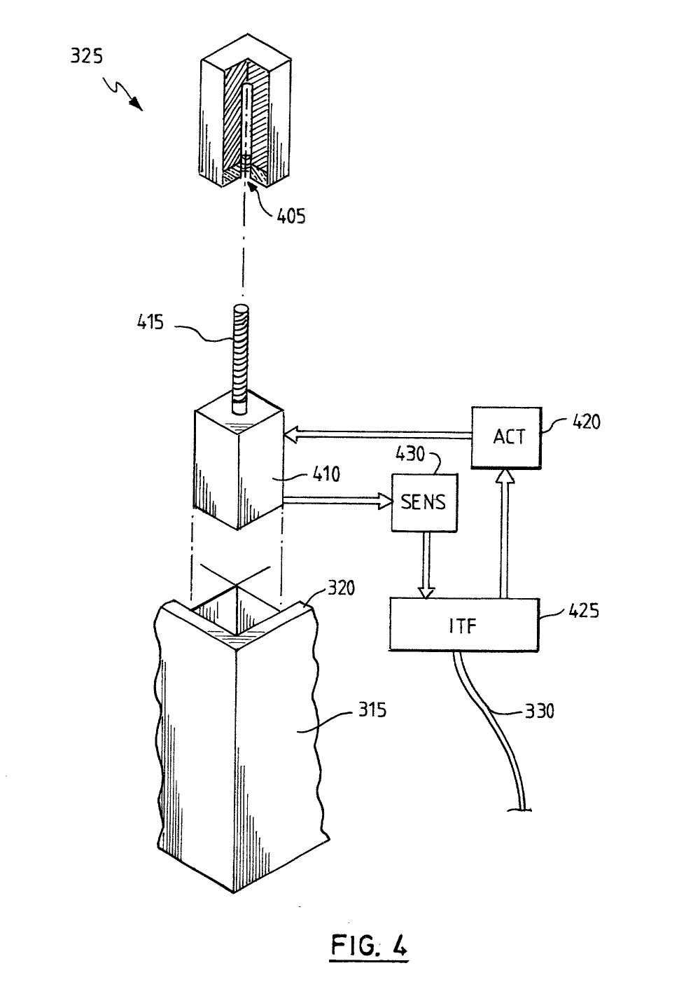

With reference to FIG. 4, each pin 325 features a threaded dead-hole 405, which extends from a lower surface thereof. The pin 325 is coupled to a rotary stepper motor 410 having an upright lead screw shaft 415. The motor 410 is securely mounted to the console 315; the pin 325 is four-sided with each side abutting one side of an adjacent pin of the matrix.

The motor 410 is operated by an actuator unit (ACT) 420, which is connected to an interface unit (ITF) 425 for the cable 330. When the motor 410 rotates the shaft 415 clockwise or counter clockwise, the mating hole 405 transfer this rotation into a linear motion, which causes the pin 325 to lower or to raise, respectively, along a longitudinal axis thereof perpendicular to the reference surface 320.

The threads are designed to be non-locking, so that the actuation of the pin 415 is reversible. Therefore, a pressure on the pin 325 causes the shaft 415 to rotate clockwise; this in turn causes an armature of the motor 410 to rotate accordingly, thereby generating a corresponding counter voltage. The counter voltage is supplied to a sensing unit (SENS) 430, which provides a corresponding signal indicative of the pressure exerted on the pin 325 to the interface unit 425.

Alternatively, the pins have a different structure (for example they are circular-shaped or triangular-shaped), the pins are operated by a different mechanism (for example using cams, solenoids, piezoelectric reeds, mechanical linkages or continuous belts), the pressure on the pins is detected in a different manner (for example using capacitance sensors or contact switches)

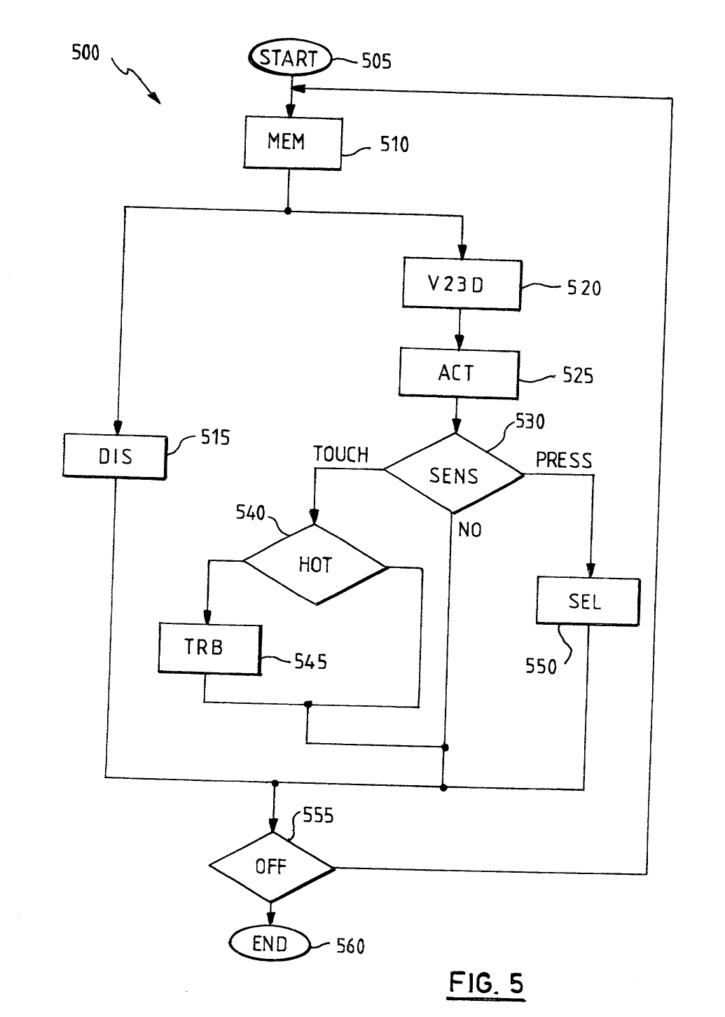

Considering now FIG. 5, when the computer is switched on a driver module managing operation of the control board associated with the monitor and the three-dimensional display runs a method 500 which starts at block 505 and then goes to block 510, wherein the video information is read from the working memory of the control board. The method then forks into two branches, which are executed in parallel. A first branch consists of block 515, while a second branch consists of blocks 520-550; the two branches merge at block 555 (described in the following).

Considering now block 515, the video information is used to drive the monitor directly; for example, the screen depicts a desktop including several icons and windows, one of which presents a web page. At the same time, at block 520, the video information is converted into the respective Braille codes and three-dimensional representations. The method continues to block 525, wherein the actuator unit drives the pins accordingly, in order to create the corresponding three-dimensional imagery.

The method checks at block 530 if a pressure has been exerted on the pins. If the user is not touching the three-dimensional display (for example if the pressure detected by the sensing unit corresponds to an average displacement of the pins lower than a threshold value, such as 0.1 mm), the method descends into block 555 directly.

If the user has touched the pins (or a portion of them) providing the three-dimensional representation of an object (for example if the average displacement of the corresponding pins ranges between the threshold value of 0.1 mm and a further higher threshold value, such as 1 mm), the method continues to block 540. The methods checks at block 540 if the current object is a hot spot (having a link associated therewith). If not, the methods proceeds to block 555 directly; conversely, the methods descends into block 545, wherein the microprocessor of the control board drives the actuator unit directly in order to cause the pins corresponding to the current object to tremble. Particularly, the actuator unit causes the pins representing the current object to swing around its operative position; for example, each pin is moved up and down at a frequency of 10 Hz and with a stroke of 1 mm. The method then passes to block 555.

If the user (block 530) has pressed the pins providing the three-dimensional representation of an object (for example if the average displacement of the corresponding pins is higher than the further threshold value of 1 mm), the methods continues to block 540, wherein the object is selected (as if clicked with the mouse), and then passes to block 555.

The method then checks at block 555 if the computer has been shut down. If not, the method returns to block 510 (for repeating the steps described above). On the contrary, the method ends at the final block 560.

Likewise considerations apply if the driver module controlling the board implements an equivalent method, if different threshold values are used, if the touching and/or the pressing of the pins associated with each object is detected in a different manner (for example when at least a pre-set percentage of the pins has been touched/pressed), if the trembling has a different frequency and stroke, and the like.

More generally, the preferred embodiment of the present invention proposes a non-visual output device for providing a non-visual representation of objects comprising means for providing a first non-visual indication consisting of a three-dimensional representation of an object, and means for providing a second non-visual indication representative of a non-shape related attribute (e.g. the presence of a hyperlink) of the object.

The devised solution allows more visual information to be conveyed to the user. Therefore, the interaction human/machine is greatly enhanced.

Moreover, the device according to the invention gives the user a quick feedback of the visual information; therefore, the user may immediately identify information of particular importance or meaning.

The proposed solution is extremely advantageous for the blind, especially when they are surfing the INTERNET. In fact, the emphasised hotspots give the user an immediate feeling of the links available.

Alternatively, the invention is implemented in a generic Graphical User Interface; in this case, the proposed solution is preferably used to emphasise active elements (such as pushable buttons and selectable menu items), giving the user an immediate feeling of the options available.

However, the solution of the invention lends itself to be implemented also in a different non-visual device (such a panel), with the device used in a different application (for example as a time table, for emphasising any delay) and even by the sighted (for example in low light conditions).

The preferred embodiment of the present invention described above offers further advantages. Particularly, the trembling of the pins is very effective and can be obtained with a low response time. The proposed structure of the pins (swinging vertically) is simple and fits into a small space.

In an embodiment of the invention, the trembling is used to represent an attribute being a digital quantity (0/1); preferably, the pins are still for a first value (for example 0), and they are trembling for a second value (1). In this way, discrimination between the two logic values is very easy. These features may be used (in addition to the applications mentioned above) for emphasising a focusing window, a bold text, a selected part of a text (when cutting/copying and pasting), and the like.

In a different embodiment of the invention, the trembling is used to represent an attribute being an analog quantity; preferably, the intensity of the trembling is proportional to the value of the analog quantity. This feature may be used to emphasise window borders, to provide an indication of the brightness (low frequency for dark object and high frequency for light object), or a feeling of the colours (regular trembling for warm colours and irregular trembling for cold colours), and the like.

Preferably, the trembling is activated only when the user touches the corresponding pins. This avoids any (detectable) interference with the adjacent pins and reduces the power consumption, which is particularly advantageous in portable devices (even if the use of this feature in a different application is not excluded).

Alternatively, the trembling is replaced by a different non-visual indication (such as the temperature of the pins or a sound), the pins are caused to tremble in a different manner (for example transversally), or the trembling is always active (with no input capability of the device).

Naturally, in order to satisfy local and specific requirements, a person skilled in the art may apply to the solution described above many modifications and alterations all of which, however, are included within the scope of protection of the invention as defined by the following claims.

What is claimed is:

1. A non-visual user interface device (170) for representing objects (335) comprising means (325,410-420) for providing a first non-visual indication representative of a first attribute of at least one object, characterised in that the device further includes means (325,410-420) for providing a second non-visual indication representative of a second attribute of said at least one object.

2. The device (170) of claim 1, wherein said first non-visual indication includes a three-dimensional representation of said at least one object.

3. The device (170) of claim 2, wherein the means (325,410-420) for providing the first non-visual indication includes a matrix of pins (325) each one having a longitudinal axis perpendicular to a reference surface (320) and means (410-420) for moving each pin along the longitudinal axis.

4. The device (170) of claim 3, wherein the second non-visual indication of said at least one object (335) includes a trembling of the corresponding means (325) providing the first non-visual indication of the object.

5. The device (170) of claim 4, wherein the means (325,410-420) for providing the second non-visual indication includes means (410-420) for causing each pin to swing along the longitudinal axis around an operative position.

6. The device (170) of claim 1, wherein the second attribute associated with said at least one object (335) is a digital quantity having a first or a second logic value, the corresponding means (325,410-420) providing the second non-visual indication of the object being in an active condition or in an inactive condition when the attribute has the first logic value or the second logic value, respectively.

7. The device (170) of claim 1, wherein the second attribute associated with said at least one object (335) is an analog quantity suitable to have a plurality of values, the corresponding means (325,410-420) providing the second non-visual indication of the object being activated with an intensity proportional to the value of the attribute.

8. The device (170) of claim 1, further comprising means (410,415,430) for detecting a touching of the means (325) providing the first non-visual indication, the means (325,410-420) providing the second non-visual indication of said at least one object being activated in response to the touching of at least a portion of the corresponding means providing the first non-visual indication of the object.

9. A data processing system (100) comprising the non-visual user interface device (170) of claim 1, a memory (115) for storing video information, and means (160) for driving the device according to the video information.

10. The system (100) of claim 9, wherein the video information is representative of a desktop with a plurality of graphical elements (335) of a graphical user interface, the objects being the graphical elements and the second attribute of said at least one object being an indication of an active condition or a disabled condition of the graphical element.

11. The system (100) of claim 10, further comprising means (175) for accessing a network (180), wherein the video information is representative of a page (350) downloaded from the network and having a plurality of elements (335), a link (355) being associated with at least one of the elements, and wherein the objects are the elements and the second attribute of said at least one object is an indication of the presence of the link associated with the element.

12. A method (500) of providing a non-visual representation of objects comprising the steps of:
providing (520,525) a first non-visual indication representative of a first attribute of at least one object,
providing (545) a second non-visual indication representative of a second attribute of said at least one object.
